(19) United States
(12) Patent Application Publication
(10) Pub. No.: US 2009/0018255 A1
(43) Pub. Date: Jan. 15, 2009

(54) COMPOSITION FOR REDUCING FUGITIVE DUST FOR SPRAY PAINT

(76) Inventor: Hee Young Kim, Gyeongsangnam-do (KR)

Correspondence Address: SAND & SEBOLT, AEGIS TOWER, SUITE 1100, 4940 MUNSON STREET, NW, CANTON, OH, 44718-3615, US

(21) Appl. No.: 12/279,480

(22) PCT Filed: Aug. 28, 2006
(86) PCT No.: PCT/KR2006/003382

§ 371 Date: Aug. 14, 2008

(30) Foreign Application Priority Data
Feb. 20, 2006 (KR) 10-2006-0016025

(51) Int. Cl. C08L 15/00; C08L 11/00; C08L 9/06

(52) U.S. Cl. 524/508; 524/502; 524/513; 524/516; 524/525

(57) ABSTRACT

A composition for reducing fugitive dust for spray paint according to the present invention comprises 5 to 23 parts by weight of a natural rubber, 1 to 10 parts by weight of a filler, 1 to 10 parts by weight of an adhesive agent, 1 to 3 parts by weight of a coupling agent, 1 to 3 parts by weight of a stabilizer, and 20 to 95 parts by weight of a solvent for dissolving the foregoing components. A spray paint compound for reducing fugitive dust may be prepared by mixing conventional paint for spraying with 3 to 10% by weight of said composition for reducing fugitive dust.

### TECHNICAL FIELD

The present invention relates to spray paint to be used in coating things like the wall with. More particularly the present invention relates to a composition for reducing fugitive dust for spray paint which reduces fugitive dust in amount significantly by mixing the foregoing with paint.

### BACKGROUND ART

A conventional method of spraying liquid paint is well known when coating the wall or ceiling of various buildings and constructions or specific items in industries. When paint is sprayed, however, dust is generated from the particles of the paint flown away.

If particles of paint fly away when the paint being sprayed, it results in the loss of the amount of the paint having flown away and causes a dust pollution problem owing to the paint particles flown away in the form of dust.

Accordingly, the present inventors in an effort to find an effective way to prevent a conventional paint from generating fugitive dust, have studied to develop a composition for reducing fugitive dust which may be applied for use in a form of the mixture with spray paint.

### DISCLOSURE OF INVENTION

### Technical Problem

An object of the present invention is to provide a composition for reducing fugitive dust which impedes as much as possible the fugitive dust generated when paint is sprayed so as to obviate pollution problems.

A further object of the present invention is to provide a composition for reducing fugitive dust which impedes as much as possible the fugitive dust generated when paint is sprayed so as to mitigate the loss of paint and thereby contribute to the reduction of cost.

Still a further object of the present invention is to provide a paint compound made up with the composition for reducing fugitive dust which decreases fugitive dust in amount significantly.

The above and the other objects of the present invention may be carried out by the present invention to be described in detail in the following.

### Technical Solution

A composition for reducing fugitive dust for spray paint according to the present invention comprises 5 to 23 parts by weight of a rubber polymer, 1 to 10 parts by weight of a filler, 1 to 10 parts by weight of an adhesive agent, 1 to 3 parts by weight of a coupling agent, and 1 to 3 parts by weight of a stabilizer, and 20 to 95 parts by weight of a solvent for dissolving the foregoing components.

A paint compound for reducing fugitive dust may be prepared by mixing 3 to 10% by weight of the composition for reducing fugitive dust for spray paint with the conventional paint for spraying.

The present invention will be described in detail in the following.

### BEST MODE FOR CARRYING OUT THE INVENTION

The composition for reducing fugitive dust for spray paint comprises 5 to 23 parts by weight of a rubber polymer, 1 to 10 parts by weight of a filler, 1 to 10 parts by weight of an adhesive agent, 1 to 3 parts by weight of a coupling agent, 1 to 3 parts by weight of a stabilizer and 20 to 95 parts by weight of a solvent for dissolving the foregoing components.

Each component will be described in detail in the following.

In regard to the rubber polymer, the foregoing to be used in the present invention may be one out of a natural rubber (NR), a chloroprene rubber (CR), a nitrilobutadiene rubber (NBR), a styrenebutadiene rubber (SBR), and the like.

In regard to the filler, the effect of the foregoing may be distinguishably different depending on the chemical composition or form during the time when the filler being compounded with a rubber polymer. The kind of the filler is classified into the organic filler and the inorganic filler depending on the chemical composition; and into the powder form, the flat board form, the needle form, the globe form, the fiber form, and the fabric form depending on the shape. Main purpose to use the filler is to improve properties of matter and process-ability, but an overuse of the filler may cause the deterioration of the properties of matter. Either one of the conventional organic filler and inorganic filler may be used for the present invention, and especially a filler having a good compatibility with a rubber polymer is preferable among the fillers usable including, for example an optic fiber, a calcium carbonate, a talc, a mica, a silica, fine particles of wood, a chalk, and the like.

Regarding the adhesive agent, a resin is preferred as the component for increasing the adhesiveness of the paint particles sprayed. A resin having the electronic charges responding to the static electricity of a rubber polymer during the time when both the r esin and the rubber polymer being mixed together is preferred, which includes for example a phenolic resin, a alkyd resin, a melamine resin, an ABS resin, a polyvinyl chloride, a ketone resin, a fluoric resin, an acrylic resin, an epoxy resin, a xylene resin, a mullein, and the like.

With regard to the coupling agent, the foregoing having both the organic functional group tending to combine with organic materials and the inorganic functional group tending to respond to inorganic materials and thereby playing a role in combining the two between the organic and the inorganic materials is generally used for improving the mechanical strength and water-resistance of the materials comprised of both the organic and the inorganic materials. The coupling agent according to the present invention has a role in improving adhesiveness, weatherability, dye process-ability, and the like of paint. As far as a coupling agent for the present invention is concerned, a silane coupling agent and a titanate coupling agent are preferred.

Regarding the stabilizer, a heat stabilizer or an ultra violet stabilizer is used for preventing paint from being damaged by the long-time exposure to heat or light. Said coupling agent and stabilizer of course are optional components in preparing process of the composition for reducing fugitive dust for spray paint. The coupling agent or stabilizer may not be used when sufficient amount of the foregoing are already contained in paint or there is no need for use.

In regard to the solvent, a thinner may be preferably used as a component for dissolving said rubber polymer, filler, adhesive agent, coupling agent, stabilizer and the like.

The composition for reducing fugitive dust comprising said components may be used in a form of the mixture comprising 3 to 10 weight % in range of the composition for reducing fugitive dust and a conventional paint for spraying.

It has been reported that the spray paint containing the composition for reducing fugitive dust according to the present invention effectuated to decrease fugitive dust in more amount than the conventional paint not containing the composition for reducing fugitive dust by about 50 to 80%.

All the above-mentioned components may be mixed with the thinner as a solvent in mixer, which may be carried out easily by those ordinarily skilled in the art.

A mixing process may also be carried out step by step for more effective combination. The final composition may be prepared by a method comprising for example the following steps of mixing a rubber polymer with an adhesive agent, mixing the resulting mixture with a filler and a thinner, and lastly mixing the resulting mixture with a coupling agent and/or a stabilizer according to need.

A spray paint compound for reducing fugitive dust may be prepared by mixing 3 to 10% by weight of the composition for reducing fugitive dust with conventional paint for spraying.

The present invention may be better understood by reference to the following examples that are intended for the purpose of illustration and are not to be construed as in any way limiting the scope of the present invention, which is defined in the claims appended hereto.

### MODE FOR THE INVENTION

### Examples 1A-1F and Comparative Examples 1A-1D

The compositions for reducing fugitive dust for spray paint pertinent to the Examples 1A to 1F and the Comparative Examples 1A to 1D were prepared in accordance with the compositions represented in the Table 1 in the following.

### Example 1A

A composition for reducing fugitive dust for spray paint was prepared by a method comprising the following steps of mixing 10 parts by weight of a natural rubber with 5 parts by weight of an ABS resin in mixer, mixing the resulting mixture together with 5 parts by weight of a calcium carbonate and 30 parts by weight of a thinner, and mixing the resulting mixture with 2 parts by weight of a silane coupling agent and 2 parts by weight of a heat stabilizer.

### Example 1B

A composition for reducing fugitive dust for spray paint was prepared by a method comprising the following steps of mixing 6 parts by weight of a natural rubber with 4 parts by weight of an ABS resin in mixer, mixing the resulting mixture with 5 parts by weight of a calcium carbonate and 50 parts by weight of a thinner, and mixing the resulting mixture together with 3 parts by weight of a silane coupling agent and 1 part by weight of a heat stabilizer.

### Example 1C

A composition for reducing fugitive dust for spray paint was prepared by a method comprising the following steps of mixing 15 parts by weight of a nitrilobutadiene and 5 parts by weight of an ABS resin in mixer, mixing the resulting mixture together with 5 parts by weight of a calcium carbonate and 40 parts by weight of a thinner, and mixing the resulting mixture with 2 parts by weight of a titanate coupling agent and 1 part by weight of a heat stabilizer.

### Example 1D

A composition for reducing fugitive dust for spray paint was prepared by a method comprising the following steps of mixing 20 parts by weight of a nitrilobutadiene with 8 parts by weight of a phenolic resin in mixer, mixing the resulting mixture together with 9 parts by weight of a calcium carbonate and 60 parts by weight of a thinner, and mixing the resulting mixture with 2 parts by weight of a titanate coupling agent.

### Example 1E

A composition for reducing fugitive dust for spray paint was prepared by a method comprising the following steps of mixing 15 parts by weight of a styrene butadiene with 7 parts by weight of an ABS resin in mixer, mixing the resulting mixture together with 7 parts by weight of a calcium carbonate and 90 parts by weight of a thinner, and mixing the resulting mixture with 2 parts by weight of a heat stabilizer.

### Example 1F

A composition for reducing fugitive dust for spray paint was prepared by a method comprising the following steps of mixing 10 parts by weight of a styrene butadiene with 5 parts by weight of a phenolic resin in mixer and mixing the resulting mixture together with 5 parts by weight of a calcium carbonate and 25 parts by weight of a thinner.

### Comparative Example 1A

A composition for reducing fugitive dust for spray paint was prepared by a method comprising the following steps of mixing 4 parts by weight of a natural rubber with 6 parts by weight of an ABS resin in mixer, mixing the resulting mixture together with 5 parts by weight of a calcium carbonate and 10 parts by weight of a thinner, and mixing the resulting mixture with 3 parts by weight of a silane coupling agent and 3 parts by weight of a heat stabilizer.

### Comparative Example 1B

A composition for reducing fugitive dust for spray paint was prepared by a method comprising the following steps of mixing 10 parts by weight of a natural rubber with 5 parts by weight of a phenolic resin in mixer, mixing the resulting mixture together with 15 parts by weight of a calcium carbonate and 30 parts by weight of a thinner, and mixing the resulting mixture with 2 parts by weight of a silane coupling agent and 2 parts by weight of a heat stabilizer.

### Comparative Example 1C

A composition for reducing fugitive dust for spray paint was prepared by a method comprising the following steps of mixing 10 parts by weight of a nitrilobutadiene with 15 parts by weight of a phenolic resin in mixer, mixing the resulting mixture together with 5 parts by weight of a calcium carbonate and 50 parts by weight of a thinner, and mixing the resulting mixture with 2 parts by weight of a silane coupling agent.

### Comparative Example 1D

A composition for reducing fugitive dust for spray paint was prepared by mixing 12 parts by weight of a nitrilobutadiene, 12 parts by weight of a melamine resin, 3 parts by weight of a calcium carbonate, and 1 part by weight of a heat stabilizer together.

TABLE 1
(Unit: Parts by Weight)

| | | | | | | | Comparative | | | |
|---|---|---|---|---|---|---|---|---|---|---|
| | Examples | | | | | | Examples | | | |
| | 1A | 1B | 1C | 1D | 1E | 1F | 1A | 1B | 1C | 1D |
| Rubber Polymer | 10 | 6 | 15 | 20 | 15 | 10 | 4 | 10 | 10 | 12 |
| Filler | 5 | 5 | 5 | 9 | 7 | 5 | 5 | 15 | 5 | 3 |
| Adhesive agent | 5 | 4 | 5 | 8 | 7 | 5 | 6 | 5 | 15 | 12 |
| Coupling Agent | 2 | 3 | 2 | 2 | — | | 3 | 2 | 2 | — |
| Stabilizer | 2 | 1 | 1 | — | 2 | | 3 | 2 | — | 1 |
| Solvent | 30 | 50 | 40 | 60 | 90 | 25 | 10 | 30 | 50 | — |

### Examples 2A-2F and Comparative Examples 2A-2D

Final paint compounds for spraying were each correspondingly prepared by mixing paint with the above-prepared compositions for reducing fugitive dust for spray paint. Compositions between the composition for reducing fugitive dust for spray paint and the paint were shown in Table 2 in the following.

TABLE 2
(Unit: Weight %)

| | | | | | | | Comparative | | | |
|---|---|---|---|---|---|---|---|---|---|---|
| | Examples | | | | | | Examples | | | |
| | 2A | 2B | 2C | 2D | 2E | 2F | 2A | 2B | 2C | 2D |
| Composition for | 3 | 5 | 7 | 8 | 9 | 10 | 1 | 15 | 20 | 25 |
| Reducing Fugitive | | | | | | | | | | |
| Dust | | | | | | | | | | |
| Paint | 97 | 95 | 93 | 92 | 91 | 90 | 99 | 85 | 80 | 75 |
| Rate of Decrease in the | 75 | 65 | 73 | 80 | 51 | 62 | 11 | 13 | 15 | 21 |
| Amount of Fugitive | | | | | | | | | | |
| Dust (%) | | | | | | | | | | |

When the above-prepared paint for spraying was sprayed, fugitive dust was observed to have decreased in the amount by the rate shown in the Table 2. Fugitive dust from the paint for spraying according to the present invention was observed to have decreased in the amount by 50 to 80% in rate whereas fugitive dust from the paint for spraying out of the scope of the present invention was observed to have decreased in the amount by the much lower rate.

Though fugitive dust in the cases of the Comparative Examples decreases in the amount, the rate of decrease is not preferable.

1. A composition for reducing fugitive dust for spray paint comprising 5 to 23 parts by weight of a rubber polymer, 1 to 10 parts by weight of a filler, 1 to 10 parts by weight of an adhesive agent, and 20 to 95 parts by weight of a solvent for dissolving the foregoing components.

2. The composition for reducing fugitive dust for spray paint as defined in claim 1, further comprising 1 to 3 parts by weight of a coupling agent and 1 to 3 parts by weight of a stabilizer.

3. The composition for reducing fugitive dust for spray paint as defined in claim 1, wherein said rubber polymer is selected from the group consisting of a natural rubber (NR), a chloroprene rubber (CR), a nitrilobutadiene rubber (NBR), and a styrene butadiene rubber (SBR).

4. The composition for reducing fugitive dust for spray paint as defined in claim 3, wherein said filler is either an organic filler or an inorganic filler.

5. The composition for reducing fugitive dust for spray paint as defined in claim 4, wherein said adhesive agent is selected from the group consisting of a phenolic resin, an alkyd resin, a melamine resin, an ABS resin, a polyvinyl chloride, a ketone resin, a fluoric resin, an acrylic resin, an epoxy resin, a xylene resin, and a mullein.

6. A spray paint compound for reducing fugitive dust containing 3 to 10% by weight of a composition for reducing fugitive dust spray paint whereby the composition comprises 5 to 23 parts by weight of a rubber polymer, 1 to 10 parts by weight of a filler, 1 to 10 parts by weight of an adhesive agent, and 20 to 95 parts by weight of a solvent for dissolving the foregoing components.

7. The composition for reducing fugitive dust for spray paint as defined in claim 2, wherein said rubber polymer is selected from the group consisting of a natural rubber (NR), a chloroprene rubber (CR), a nitrilobutadiene rubber (NBR), and a styrene butadiene rubber (SBR).

8. The composition for reducing fugitive dust for spray paint as defined in claim 7, wherein said filler is either an organic or an inorganic filler.

9. The composition for reducing fugitive dust for spray paint as defined in claim 8, wherein said adhesive agent is selected from the group consisting of a phenolic resin, an alkyd resin, a melamine resin, an ABS resin, a polyvinyl chloride, a ketone resin, a fluoric resin, an acrylic resin, an epoxy resin, a xylene resin, and a mullein.
